(19) United States
(12) Patent Application Publication
(10) Pub. No.: US 2003/0151891 A1
(43) Pub. Date: Aug. 14, 2003

(54) Universal cableless drive adapter for a portable computer data storage device

(76) Inventor: Dieter Paul, Anaheim, CA (US)

Correspondence Address: MORLAND C FISCHER, 2030 MAIN ST, SUITE 1050, IRVINE, CA, 92614

(21) Appl. No.: 10/073,835

(22) Filed: Feb. 13, 2002

(51) Int. Cl. G06F 1/16

(52) U.S. Cl. 361/686; 361/685

(57) ABSTRACT

A universal cableless drive adapter by which a removable carrier can be electrically coupled to a portable computer data storage (e.g. a disk or tape drive) so that the data storage device can communicate with an SCSI bus in a small computer system network while avoiding the common use of ribbon cable and the effects caused by the corresponding stub length on the bus. The universal cableless adapter is attached to the removable drive and includes a fixed I/O connector and a DC power plug, the position of which is adjustable relative to the position of the power connector on the data storage device. Accordingly, the removable carrier can be efficiently coupled to a variety of different computer data storage devices, regardless of the manufacturer of the data storage device, the position of the power connector thereof and the distance between the data storage device and its removable carrier.

### BACKGROUND OF THE INVENTION

1. Field of the Invention

This invention relates to a universal cableless drive adapter by which a removable carrier can be coupled to different portable computer data storage devices (e.g. a disk or tape drive) to be transported in the carrier, regardless of the location of the power connector of the data storage device or the manufacturer thereof. By virtue of the foregoing, the portable computer data storage device can be removably received in an external data expansion chassis in order to communicate with an SCSI bus in a small computer system network while avoiding the use of ribbon cable and the effects caused by the corresponding stub length on the SCSI bus.

2. Background Art

FIGS. 1-3 of the drawings show a conventional removal carrier 10 detachably connected to a U-shaped receiving frame 12. As is best shown in FIG. 2, a portable computer data storage device (e.g. a hard drive, a tape drive, or the like) 14 is fixedly attached to the removable carrier 10 so that the carrier 10 and the portable data storage device 14 are removable as a unit from their receiving frame 12. As shown in FIG. 1, the portable data storage device 14 is enclosed by a protective top cover 16. One or more receiving frames are typically mounted in respective drive bays of an external data expansion chassis (not shown) to receive corresponding removable carriers and their data storage devices in order to provide additional storage capacity for a personal computer, a workstation, or the like. When a removable carrier 10 is returned to its receiving frame 12 at an external data expansion chassis, the portable data storage device 14 thereof is coupled to and operated from an SCSI bus of a small computer system network.

The removable carrier 10 slides reciprocally inwardly towards and outwardly from its receiving frame 12 via side rails 17 so that the portable computer data storage device 14 may be advantageously transported from place to place by means of a handle 18. Accordingly, the portable data storage device 14 may be easily moved to a different external data expansion chassis or to a secure location at which to guard the contents of the data stored therein.

As is best shown in FIGS. 2 and 3, when the removable carrier 10 is slidably received inwardly of its receiving frame 12, a pair of locking pins 20 that extend from the back of receiving frame 12 are received in respective pin holes 22 at the rear end of the removable carrier 10, whereby the carrier 10 is mated to the frame 12. In this manner, an I/O connector 24 that is mounted at the backplane of the receiving frame 12 with a plurality of connector pins projecting outwardly therefrom is aligned to be mated with a complementary connector (designated 26 in FIG. 3) that is located at the rear of the removable carrier 10 in order to permit the portable computer data storage device 14 to communicate with and receive control and data signals from the SCSI bus in the small computer system network.

The connection between the portable computer data storage device 14 and its removable carrier 10 has heretofor been characterized by inflexibility and relatively long stub lengths. By way of one example of a means by which to connect the data storage device 14 to I/O mating connector 26, and referring to FIG. 4 of the drawings, one end of a conventional flat ribbon cable 30 is connected to a cable-to-printed circuit board connector 32 that is mounted on the front face of a printed circuit board 28 at the rear of the removable carrier 10. The opposite end of ribbon cable 30 terminates at a standard I/O connector 34. A set of power wires 36 runs from the printed circuit board 28 to a DC power plug 40 by which to provide DC power to the computer data storage device 14.

As will be known to those skilled in the art, the length of the ribbon cable 30 of FIG. 4 requires sufficient space between the portable computer data storage device 14 and the rear of its receiving frame 12 which prohibits a compact carrier configuration. Moreover, signal distortion, impedance mismatches and parasitic capacitance are often introduced on the SCTI bus by the relatively long stub length as a consequence of the ribbon cable 30 that is required in the example of FIG. 4 to couple the data storage device 14 to its SCSI bus.

By way of a second example of a means by which to couple the portable computer data storage device 14 to the mating I/O connector 26 (of FIG. 3) and turning to FIG. 5 of the drawings, an elongated one piece connector body 42 is mounted on the printed circuit board 28 at the rear of the removable carrier 10. The one piece connector body 42 includes a first connector portion 44 by which DC power is provided to the data storage device 14, a second connector portion 46 which is reserved for optional SCSI functions and a third I/O connector portion 48 from which data and control signals are transmitted between data storage device 14 and its SCSI bus.

However, and as will also be known to those skilled in the art, the one piece connector body 42 of FIG. 5 is rigid such that the connector portions 44, 46 and 48 thereof are inflexible and cannot be repositioned relative to one another. That is to say, the locations of the connector portions 44, 46 and 48 of connector body 42 are fixed and cannot be changed to be aligned with the receiving connector configurations that are manufactured into different portable computer data storage devices. Because the distance between the one piece connector body 42 at the rear of removable carrier 10 and the data storage device 14 will vary from storage device-to-storage device, not every portable computer data storage device will be compatible with the rigid one piece connector configuration 42 at the rear of the removable carrier 10 of FIG. 5. Consequently, different one piece connector configurations will be required depending upon the size and manufacturer of the data storage devices to be coupled to the carrier.

In this regard, it would be desirable to eliminate the inherent problems of space consumption, stub length and the fixed, inflexible connector positions that are associated with the ribbon cable 30 of FIG. 4 and the one piece connector body 42 of FIG. 5 when a portable computer data storage device 14 is to be coupled to the I/O mating connector 26 of its removable carrier 10. What would be desirable is a universal adapter that is capable of enabling a variety of different portable computer data storage devices to be connected to the I/O mating connector 26 regardless of the position of the power connector on or manufacturer of the data storage device 14.

### SUMMARY OF THE INVENTION

In general terms, a universal cableless drive adapter is disclosed by which a carrier, that is removably received in a drive bay of an external computer storage enclosure, can be electrically coupled to a variety of different portable computer data storage devices (e.g. a disk or tape drive) that is transported within the removable carrier. By virtue of the foregoing, a single adapter will be suitable to enable the portable computer data storage device to be connected to and communicate with its SCSI bus regardless of the size, location of the power connector or manufacturer of the data storage device and the distance between the data storage device and the rear of the removable carrier therefor. The drive adapter of this invention eliminates the use of space consuming ribbon cable and the inherent problems of signal distortion, impedance mismatches and parasitic capacitance that are often introduced by the relatively long stub length that has heretofor been required to couple a portable computer data storage device to an SCSI bus in a small computer system network. Thus, the common stub length between the portable computer data storage device and the SCSI bus will be effectively eliminated or substantially reduced to facilitate accurate, high speed data communication therebetween.

The universal drive adapter of this invention includes an I/O drive interface connector and a DC power plug that are to be detachably connected to the portable computer data storage device. The I/O drive interface connector is mounted on a printed circuit board at the rear of the removable carrier for direct plug-in to the portable computer data storage device. The DC power plug which provides power to the data storage device is electrically connected from the printed circuit board at the rear of the removable carrier to the data storage device by means of a plurality of (e.g. four) power wires. The power wires are flexible and can be bent or stretched on an as-needed basis to reach any position of the portable computer data storage device within the removable carrier. Accordingly a reliable connection is possible between the DC power plug at the end of the power wires and any one of a number of different portable computer data storage devices regardless of the size and manufacturer of the data storage device and the distance between the data storage device and the rear of its removable carrier.

### BRIEF DESCRIPTION OF THE DRAWINGS

FIG. 1 shows a known removable carrier for a portable computer data storage device detachably connected to its receiving frame;

FIGS. 2 and 3 show the removable carrier of FIG. 1 capable of being detached from or positioned inwardly of its receiving frame;

FIG. 4 shows a ribbon cable as one example of a conventional means for electrically coupling a portable computer data storage device to its removable carrier;

FIG. 5 shows an inflexible, one piece connector body as another example of a means for electrically coupling a portable computer data storage device to its removable carrier; and

FIGS. 6 and 7 illustrate the universal cableless drive adapter which forms the present invention by which to efficiently couple a portable computer data storage device to its removable carrier regardless of the size or manufacturer of the data storage device.

### DETAILED DESCRIPTION

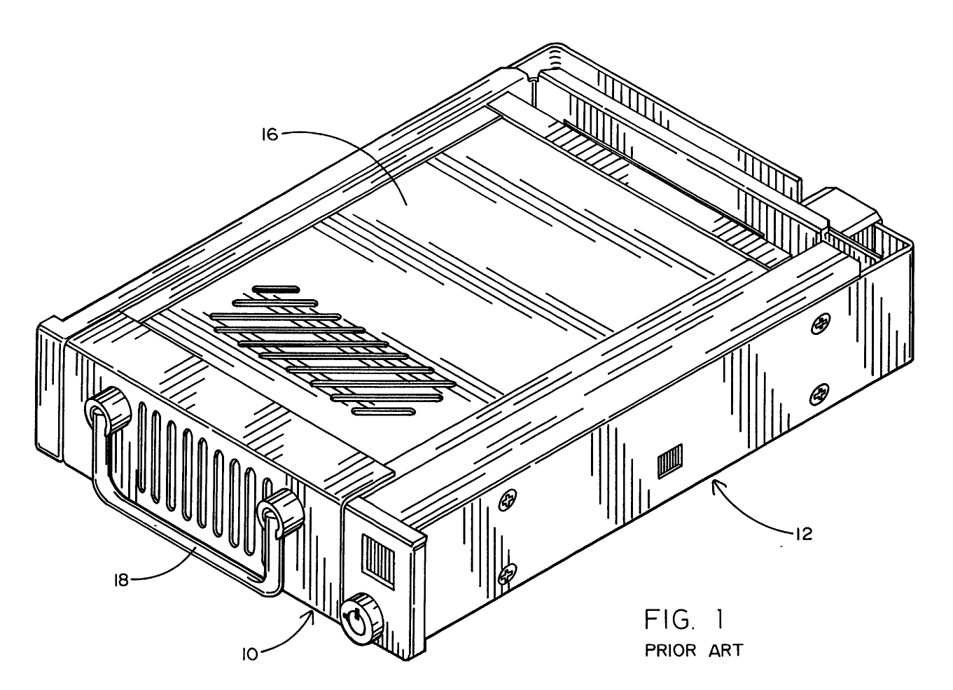

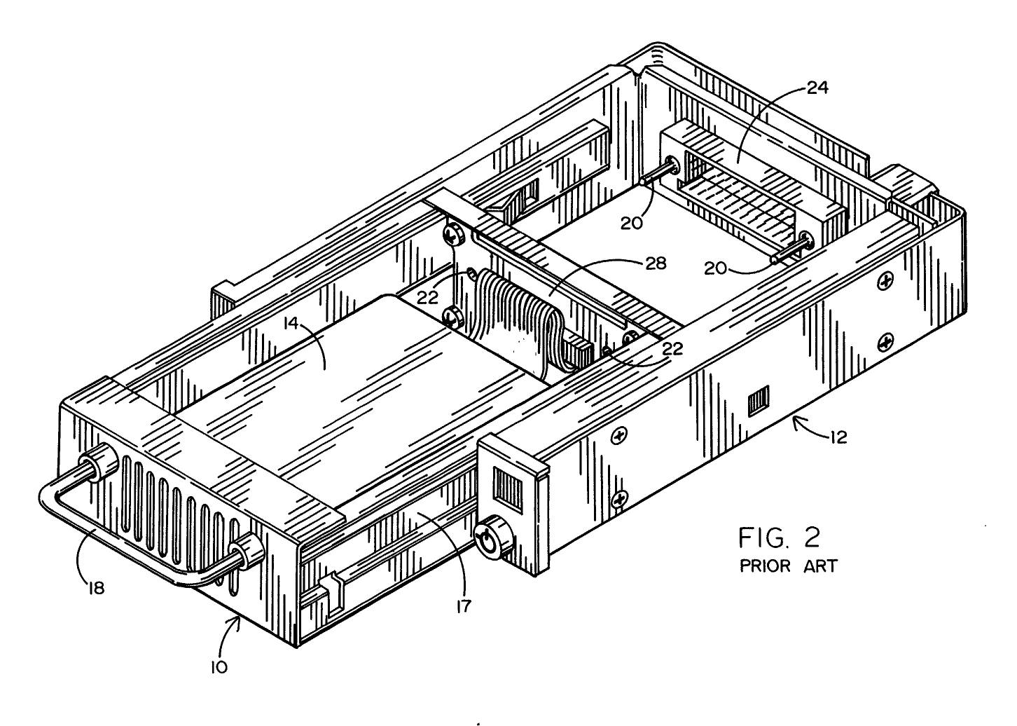

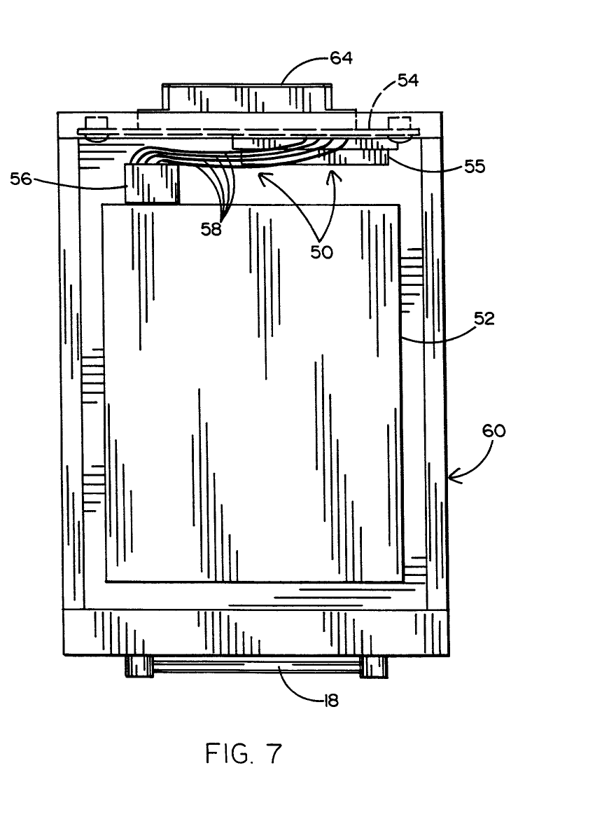

The improvement which forms the present invention is now described while referring to FIGS. 6 and 7 of the drawings, where there is shown a universal cableless drive adapter 50 that is carrier by a printed circuit board 54 at the rear of a removable carrier 60, like that shown in FIGS. 1-3. The drive adapter 50 is advantageously capable of being mated to a variety of different portable computer data storage devices (e.g. a disk drive, a tape drive and the like) 52 from any manufacturer, regardless of the size of the data storage device and the distance between the data storage device and the printed circuit board 54 at the rear of the removable drive carrier 60.

More particularly, the universal drive adapter 50 includes an I/O drive interface connector 55 and a plug 56 that are suitable to be detachably connected to the portable computer data storage device 52 which is affixed to the bottom of its removable carrier 60. The I/O drive interface connector 55 is mounted on the printed circuit board 54 at the rear of carrier 60 for direct plug-in to the data storage device 52, whereby the data storage device 52 can communicate with its SCSI bus via I/O mating connector 64 (best shown in FIG. 7) when the removable carrier 60 is located inwardly of its receiving frame (designated 12 in FIGS. 1-3).

The DC power plug 56 provides DC power to the data storage device 52. As an important detail of this improvement, the power plug 56 is electrically connected to the printed circuit board 54 at the rear of removable carrier 60 by means of a plurality of (e.g. four) power wires 58. In this regard, it can be appreciated that the power wires 58 are flexible and can be bent or stretched on an as-needed basis to reach any location of the portable computer data storage device 52. Accordingly, a reliable connection is possible between the DC power plug 56 at the end of the flexible power wires 58 and any one of a number of different data storage devices 52 that are transported within the removable carrier 60. That is to say, regardless of the size and manufacturer of the data storage device 52 and the corresponding distance between the data storage device 52 and the printed circuit board 54 at the rear of its removable carrier 60, by manipulating (e.g. pulling, bending, etc.) the power wires 58 that extend from the printed circuit board 54, the DC power plug 56 can be quickly and easily positioned and mated directly to data storage device 52. Moreover, the flexible nature of the power wires 58 enables the DC power plug 56 to be repositioned any number of times so as to be detachably connected to a portable computer data storage device regardless of the location of the DC power input port thereof.

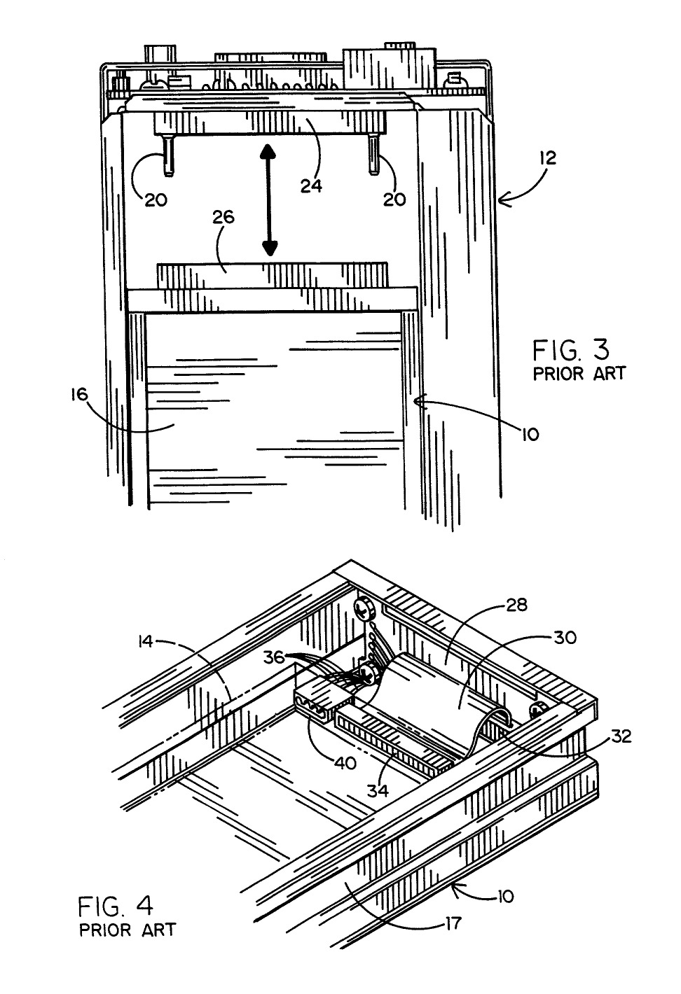

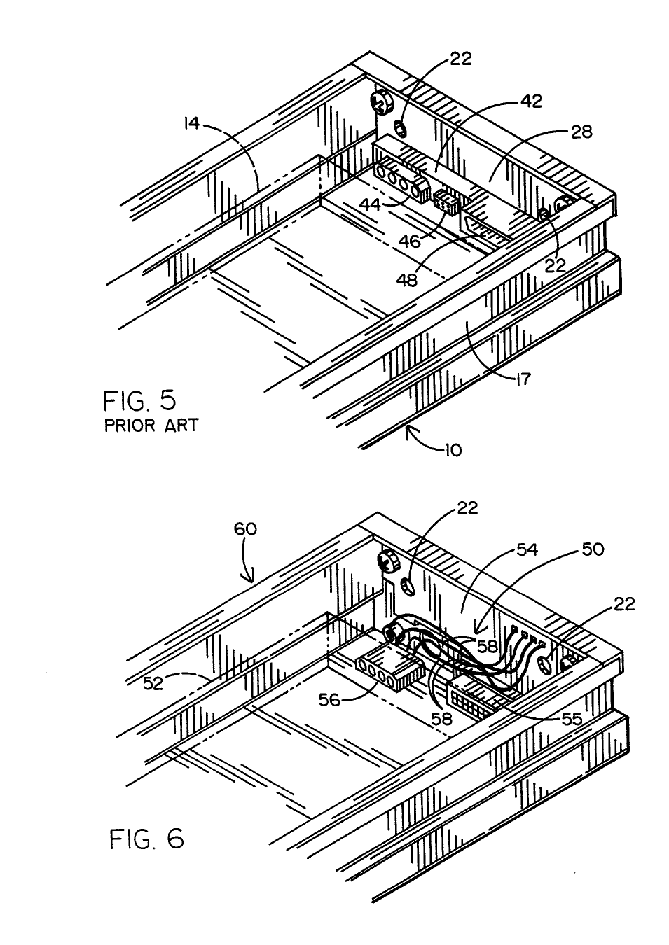

By virtue of the foregoing, the problems inherent with the conventional ribbon cable and fixed position coupling connectors of FIGS. 4 and 5 are overcome. Therefore, only a single removable carrier 60 bearing the universal cableless drive adapter 50 of this invention will be necessary to carry different computer data storage devices having different sizes, power connector locations and manufacturers. This results in a more efficient and less costly assembly process for those in the business of manufacturing and using small computer systems and external data expansion chassis therefor. In this same regard, the I/O drive interface connector 55 of drive adapter 50 that is mounted on the printed circuit board 54 at the rear of removable carrier 60 can be any commercially available 40 or 80 pin connector to enhance the universal characteristic and efficiency of the cableless drive adapter 50 that has been disclosed above.

I claim:

1. For a removable carrier and a portable computer data storage device having an input power connector and being transported within said removable carrier, a drive adapter by which the portable computer data storage device and the removable carrier are electrically coupled to one another to enable the portable computer data storage device to communicate with a computer system, said drive adapter avoiding the use of a ribbon cable electrical coupler and comprising an I/O connector mounted on the removable carrier to be plugged directly into the portable computer data storage device so that said data storage device can receive and transmit control and data signals, and a power plug to be mated to the input power connector of the portable computer data storage device to supply power thereto, the position of said power plug being adjustable relative to the position of the input power connector of said data storage device regardless of the size of said data storage device and the distance between said data storage device and the removable carrier therefor.

2. The drive adapter recited in claim 1, wherein said I/O connector is mounted on a printed circuit board that is affixed to said removable carrier so that said I/O connector lies in opposite facing alignment with said portable computer data storage device.

3. The drive adapter recited in claim 2, wherein said power plug is electrically connected to the printed circuit board affixed to said removable carrier.

4. The drive adapter recited in claim 3, wherein said power plug is electrically connected to said printed circuit board by means of a plurality of electrical wires.

5. The drive adapter recited in claim 4, wherein said electrical wires to connect said power plug to said printed circuit board are flexible so as to be bent and stretched to enable the position of said power plug to be adjusted relative to the position of the input power connector of said portable computer data storage device.
